(19) United States
(12) Patent Application Publication
(10) Pub. No.: US 2026/0310495 A1
(43) Pub. Date: Oct. 8, 2026

(54) Backup via Multiple Temporary Dynamic Cloud Buckets

(71) Applicant: Dell Products L.P., Round Rock, TX (US)

(72) Inventors: Kaushik Gupta, Pune (IN); Shiv S. Kumar, Pune (IN)

(21) Appl. No.: 19/170,955

(22) Filed: Apr. 4, 2025

(51) Int. Cl. G06F 11/14; G06F 9/48

(52) U.S. Cl. CPC G06F 9/4881

(57) ABSTRACT

A system can initiate copying of object data to a bucket of a cloud platform, wherein the cloud platform implements a per-bucket request rate limit, and wherein the copying is effectuated via a group of tasks. The system can, based on the initiating, create at least one temporary bucket on the cloud platform. The system can assign respective tasks of the group of tasks to the bucket or to respective temporary buckets of the at least one temporary bucket, wherein the group of tasks effectuates the copying after the assigning. The system can, based on the copying completing, copy data of the at least one temporary bucket to the bucket, and delete the at least one temporary bucket.

### BACKGROUND

Computer data can be backed up as data objects in an object storage system that is provided by a cloud computing platform.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can initiate copying of object data to a bucket of a cloud platform, wherein the cloud platform implements a per-bucket request rate limit, and wherein the copying is effectuated via a group of tasks. The system can, based on the initiating, create at least one temporary bucket on the cloud platform. The system can assign respective tasks of the group of tasks to the bucket or to respective temporary buckets of the at least one temporary bucket, wherein the group of tasks effectuates the copying after the assigning. The system can, based on the copying completing, copy data of the at least one temporary bucket to the bucket, and delete the at least one temporary bucket.

An example method can comprise, based on initiating copying of object data to a bucket of a cloud platform, creating, by a system comprising at least one processor, at least one temporary bucket on the cloud platform, wherein the cloud platform implements a per-bucket request rate limit. The method can further comprise assigning, by the system, respective tasks of tasks to the bucket or to respective temporary buckets of the at least one temporary bucket, wherein the group of tasks effectuates the copying after the assigning. The method can further comprise, based on the copying completing, copying, by the system, data of the at least one temporary bucket to the bucket before deleting the at least one temporary bucket.

An example non-transitory computer-readable medium can comprise instructions that, in response to execution, cause a system comprising a processor to perform operations. These operations can comprise creating at least one temporary bucket on a cloud platform, wherein the cloud platform comprises a bucket and implements a per-bucket request rate limit. These operations can further comprise assigning respective worker processes to the bucket or to respective temporary buckets of the at least one temporary bucket, wherein the worker processes perform the copying. These operations can further comprise, based on the copying being determined to have completed, copying data of the at least one temporary bucket to the bucket before deleting the at least one temporary bucket.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate backup via multiple temporary dynamic cloud buckets, in accordance with an embodiment of this disclosure;

FIG. 2 illustrates another example system architecture that can facilitate backup via multiple temporary dynamic cloud buckets, in accordance with an embodiment of this disclosure;

FIG. 3 illustrates an example of adding temporary buckets based on a per-bucket limit, and that that can facilitate backup via multiple temporary dynamic cloud buckets, in accordance with an embodiment of this disclosure;

FIG. 4 illustrates an example of handling a “slow-down” request, and that that can facilitate backup via multiple temporary dynamic cloud buckets, in accordance with an embodiment of this disclosure;

FIG. 5 illustrates an example of moving data from temporary buckets to a target bucket, and that that can facilitate backup via multiple temporary dynamic cloud buckets, in accordance with an embodiment of this disclosure;

FIG. 6 illustrates an example of deleting temporary buckets, and that that can facilitate backup via multiple temporary dynamic cloud buckets, in accordance with an embodiment of this disclosure;

FIG. 7 illustrates an example of round robin load balancing, and that that can facilitate backup via multiple temporary dynamic cloud buckets, in accordance with an embodiment of this disclosure;

FIG. 8 illustrates an example of minimum-number-of-in-progress-tasks load balancing, and that that can facilitate backup via multiple temporary dynamic cloud buckets, in accordance with an embodiment of this disclosure;

FIG. 9 illustrates another example process flow that can facilitate backup via multiple temporary dynamic cloud buckets, in accordance with an embodiment of this disclosure;

FIG. 10 illustrates another example process flow that can facilitate backup via multiple temporary dynamic cloud buckets, in accordance with an embodiment of this disclosure;

FIG. 11 illustrates another example process flow that can facilitate backup via multiple temporary dynamic cloud buckets, in accordance with an embodiment of this disclosure; and

FIG. 12 illustrates an example block diagram of a computer operable to execute an embodiment of this disclosure.

### DETAILED DESCRIPTION

### Overview

A cloud endpoint can generally comprise a network-accessible interface to access a cloud computing service. A problem with cloud endpoints can be that they have a “maximum requests per second” limit for a bucket in an object storage system. A bucket can generally comprise a logical container used to store and manage objects (e.g., files, metadata, and associated data) in an object storage system.

Different cloud endpoints can have different maximum requests per second limits, such as 3,500, 1,000, or 20,000.

A further problem relating to a “maximum requests per second” limit for a bucket in a cloud endpoint can relate to a storage system that is capable of more than the maximum requests per second, where that storage system is to interact with the cloud endpoint. It can be that such a storage system must slow down its request rate when interacting with a slower, rate limited cloud endpoint.

There can be a component or service within a computer storage system that manages data movement operations, and an example component/service can default to 500 tasks per node (where a task can comprise a worker process that performs a data copying function). That means that, for a 20-node cluster, there could be 500*20=10,000 tasks (that result in cloud requests) operating at the same time. Where each of these tasks is making a request to the same cloud endpoint, this could result in a rate limit being exceeded.

Then, for batch tasks (where one task processes many small files), the total number requests could even further beyond the cloud endpoint's rate limit.

There can be a problem where this occurs, and after a certain number of failed attempts (e.g., 3), the task fails. A way to address this problem can be to decrease the task count, but this can carry with it another problem of increasing a total amount of time for a job to complete.

A task can generally comprise a worker thread or a worker process. A copy job can create multiple tasks (work items) in a queue. A task can pick each work item and process it.

A task can move one file. Where files are small, multiple files can be packed together (e.g., into a 1 gigabyte (or smaller) group), and that pack can be moved by a task. A task can be assigned to a bucket for copying, where then tasks effectuate the copying task on the bucket.

The present techniques can be implemented to address these problems. For copying data to a cloud endpoint, temporary buckets can be created (where each bucket has its own rate limit). Then, once the data has been copied (across multiple buckets), the objects on the cloud can be collected in a single bucket. Each cloud service provider can maintain an application programming interface (API) for facilitating copying of objects between buckets.

An example workflow of the present techniques can be as follows. When a copy job begins, create N temporary buckets.

A load balancer can be implemented that can be aware of the total number of available buckets on the cloud endpoint. Where the load balancer is configured to proceed round robin, it can keep looping through the set of available buckets and assign a bucket as the target account for the next task that is created.

Where the load balancer is configured to consider load on the target bucket, it can keep a track of in-progress tasks for a given bucket. The bucket that has minimum number of in-progress tasks can be assigned to the next task that is created.

A total number of tasks per bucket can be monitored. If the total number of tasks per bucket is greater than or equal to 95% of the threshold for that bucket, a new temporary bucket can be created and added to the list of the temporary buckets for the given copy job.

A new temporary bucket can also be created where a task fails with a “slow down” request. A reason for this can be that batch task can have P files, and it can result in P requests. Thus, just monitoring the total number of tasks can be insufficient to address problems with prior approaches.

A cloud platform's object storage APIs can be invoked to copy all the data from the temporary buckets to one intended bucket. In some examples, this can be a single API call per bucket. Once the objects are in the intended bucket, the temporary buckets can be deleted.

### Example Architectures, etc

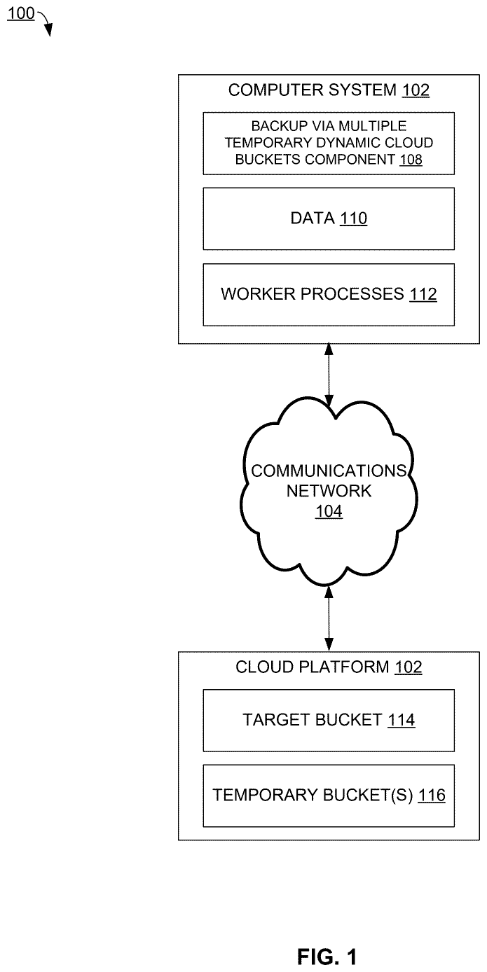

FIG. 1 illustrates an example system architecture 100 that can facilitate backup via multiple temporary dynamic cloud buckets, in accordance with an embodiment of this disclosure.

System architecture 100 comprises cloud platform 102, communications network 104, and computer system 106. In turn, cloud platform 102 comprises target bucket 114 and temporary bucket(s) 116. And, computer system 106 comprises backup via multiple temporary dynamic cloud buckets component 108, data 110, and worker processes 112.

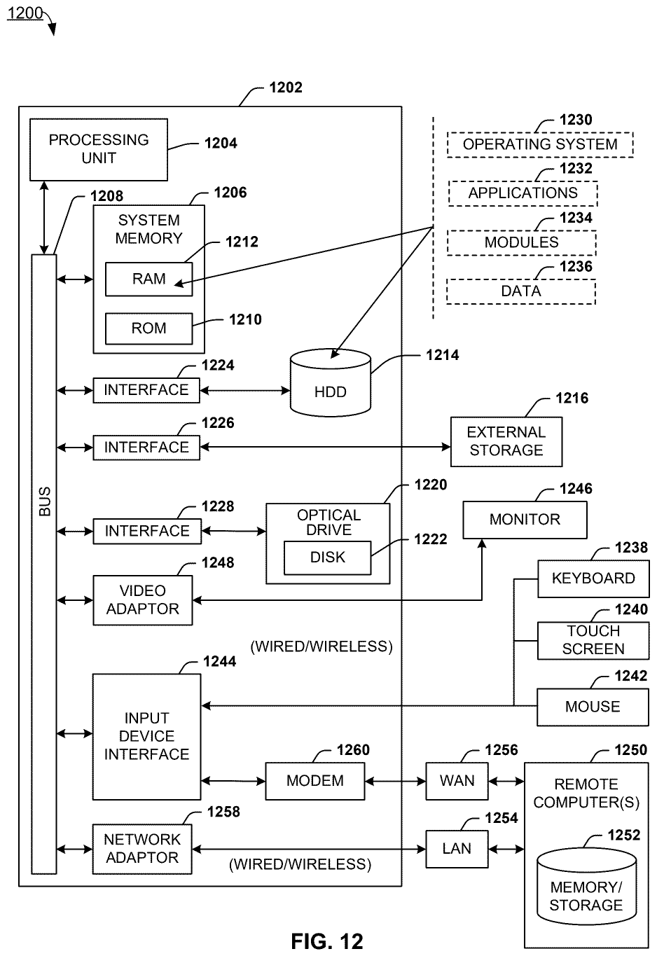

Each of cloud platform 102 and/or computer system 106 can be implemented with part(s) of computing environment 1200 of FIG. 12. Communications network 104 can comprise a computer communications network, such as the Internet.

Computer system 106 can copy data 110 to cloud platform 102. Cloud platform 102 implements a per-bucket rate limit. Backup via multiple temporary dynamic cloud buckets component 108 can create temporary bucket(s) 116, and direct various worker processes of worker processes 112 to copy parts of data 110 to various temporary buckets of temporary bucket(s) or to target bucket 114.

When all of data 110 has been copied to cloud platform 102, backup via multiple temporary dynamic cloud buckets component 108 can direct the data in temporary bucket(s) 116 to be copied to target bucket 114, then delete temporary bucket(s) 116. In this manner, data 110 can be copied from computer system 106 to target bucket 114, while accounting for a per-bucket rate limit of cloud platform 102.

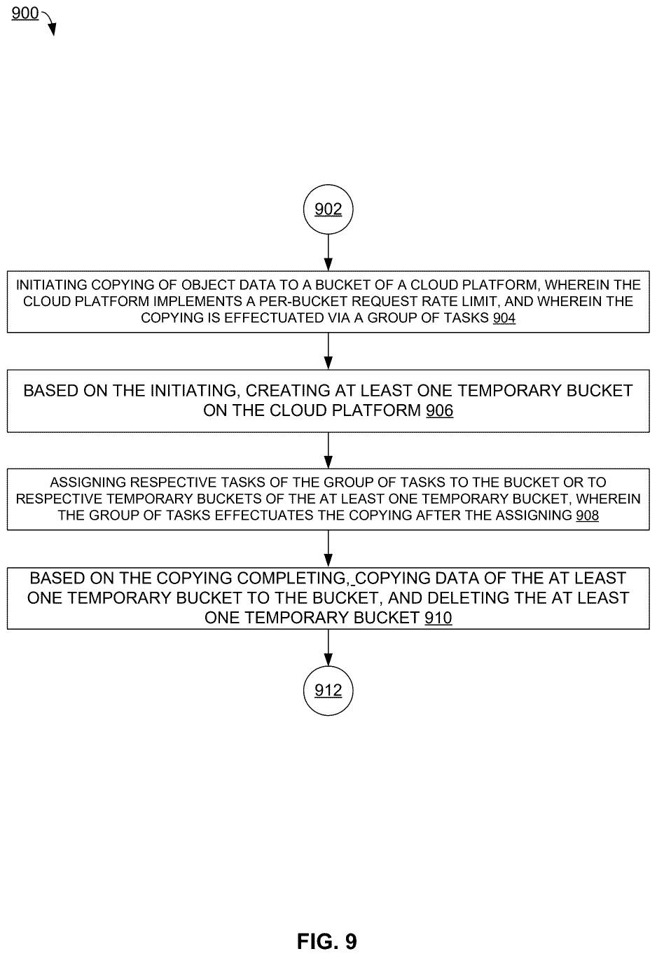

In some examples, backup via multiple temporary dynamic cloud buckets component 108 can implement part(s) of the process flows of FIGS. 9-11 to implement backup via multiple temporary dynamic cloud buckets.

It can be appreciated that system architecture 100 is one example system architecture for backup via multiple temporary dynamic cloud buckets, and that there can be other system architectures that facilitate backup via multiple temporary dynamic cloud buckets.

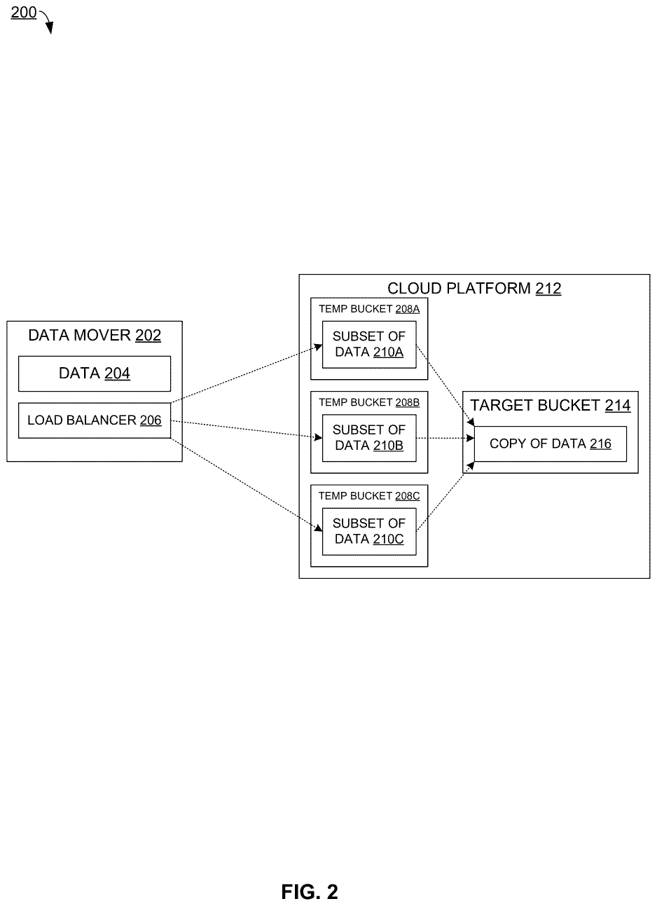

FIG. 2 illustrates another example system architecture 200 that can facilitate backup via multiple temporary dynamic cloud buckets, in accordance with an embodiment of this disclosure. In some examples, part(s) of system architecture 200 can be used by part(s) of system architecture 100 of FIG. 1 to facilitate backup via multiple temporary dynamic cloud buckets.

System architecture 200 comprises data mover 202, data 204, load balancer 206, temporary bucket 208A, temporary bucket 208B, temporary bucket 208C, subset of data 210A, subset of data 210B, subset of data 210C, cloud platform 212, target bucket 214, and copy of data 216.

In some examples, a data copy according to the present techniques can involve two phases. In a first phase, data 204 is copied to temporary bucket 208A, temporary bucket 208B, and temporary bucket 208C (as subset of data 210A, subset of data 210B, and subset of data 210C). When that is complete, in a second phase, subset of data 210A, subset of data 210B, and subset of data 210C can be copied to target bucket 214 as copy of data 216. Temporary bucket 208A, temporary bucket 208B, and temporary bucket 208C can then be deleted.

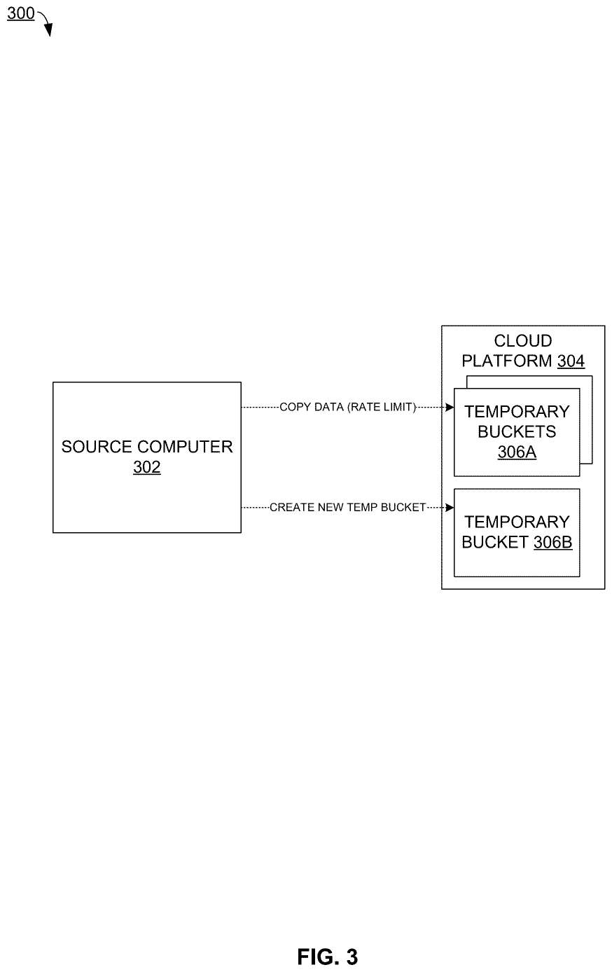

FIG. 3 illustrates an example 300 of adding temporary buckets based on a per-bucket limit, and that that can facilitate backup via multiple temporary dynamic cloud buckets, in accordance with an embodiment of this disclosure. In some examples, part(s) of example 300 can be used by part(s) of system architecture 100 of FIG. 1 to facilitate backup via multiple temporary dynamic cloud buckets.

Example 300 comprises source computer 302, cloud platform 304, temporary buckets 306A, and temporary bucket 306B.

In example 300, source computer 302 is copying data to temporary buckets 306A and a rate limit has been reached or is being approached. As a result, source computer 302 sends an API call to cloud platform 304 to create another bucket-temporary bucket 306B-which can be used for copying in addition to temporary buckets 306A.

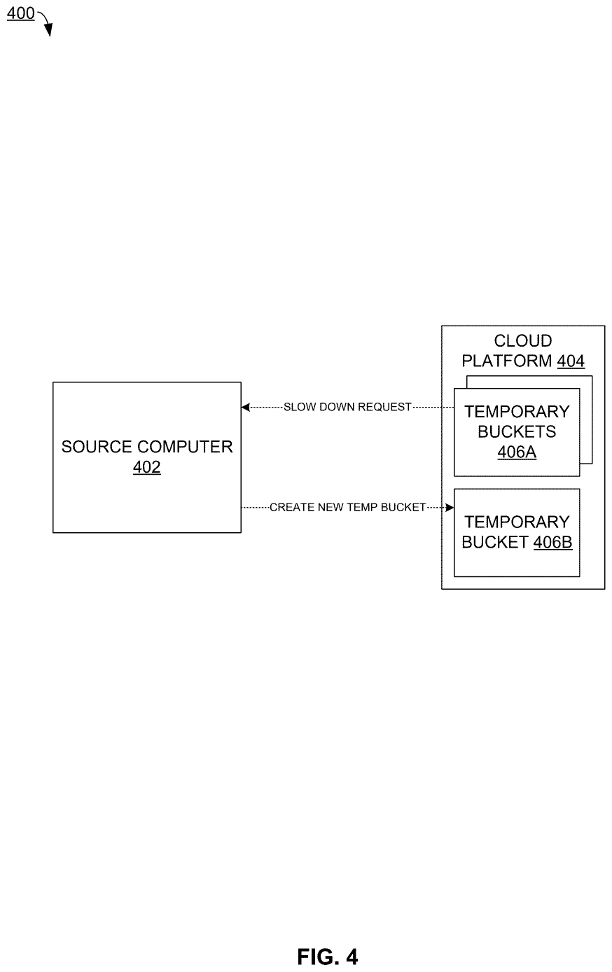

FIG. 4 illustrates an example 400 of handling a “slow-down” request, and that that can facilitate backup via multiple temporary dynamic cloud buckets, in accordance with an embodiment of this disclosure. In some examples, part(s) of example 400 can be used by part(s) of system architecture 100 of FIG. 1 to facilitate backup via multiple temporary dynamic cloud buckets.

Example 400 comprises source computer 402, cloud platform 404, temporary buckets 406A, and temporary buckets 406B.

In example 400, source computer 402 is copying data to temporary buckets 406A and cloud platform 404 sends a “slow down” request to source computer 402. As a result, source computer 402 sends an API call to cloud platform 404 to create another bucket—temporary bucket 406B—which can be used for copying in addition to temporary buckets 406A.

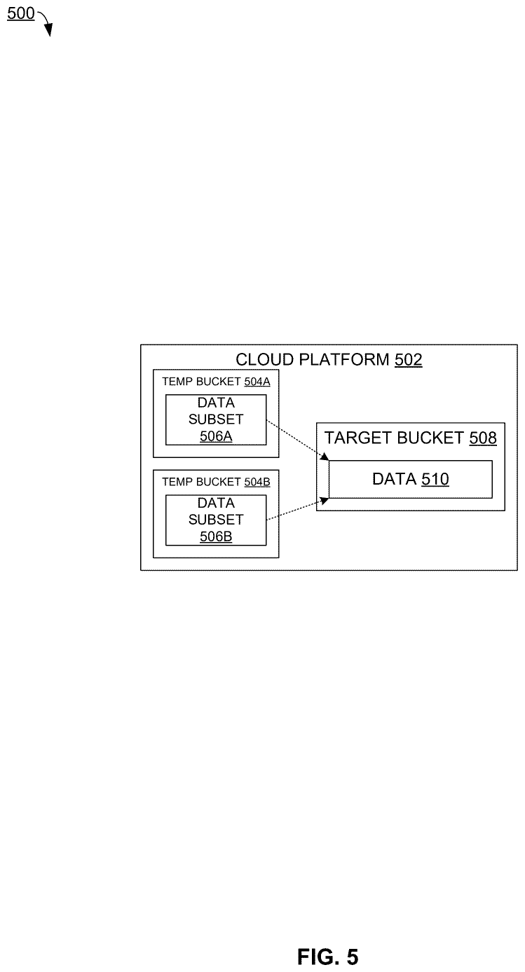

FIG. 5 illustrates an example 500 of moving data from temporary buckets to a target bucket, and that that can facilitate backup via multiple temporary dynamic cloud buckets, in accordance with an embodiment of this disclosure. In some examples, part(s) of example 500 can be used by part(s) of system architecture 100 of FIG. 1 to facilitate backup via multiple temporary dynamic cloud buckets.

Example 500 comprises cloud platform 502, temporary bucket 504A, temporary bucket 504B, data subset 506A, data subset 506B, target bucket 508, and data 510.

In example 500, once data has been fully copied to cloud platform 502 and is stored across temporary bucket 504A and temporary bucket 504B (and possibly target bucket 508), the data in the temporary buckets-data subset 506A and data subset 506B-can be copied to target bucket 508, so that all of the copied data is in target bucket 508 as data 510.

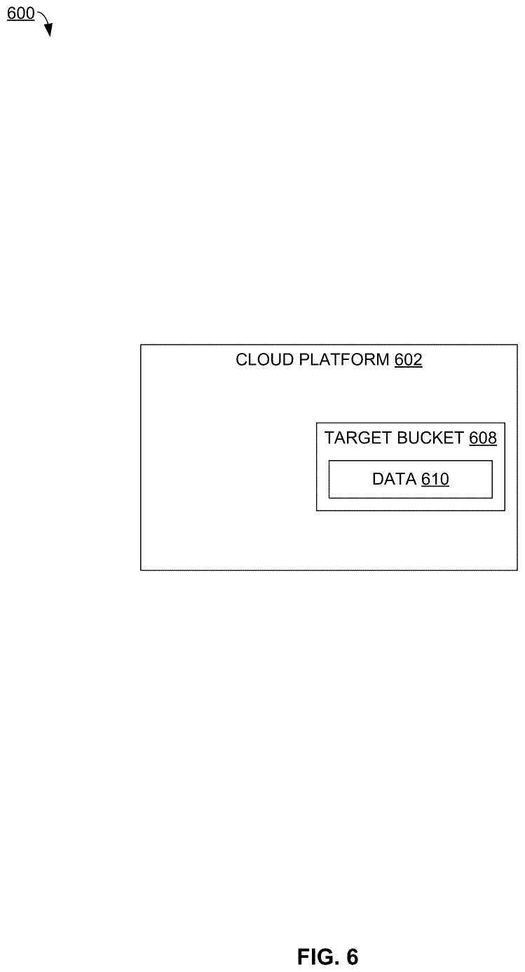

FIG. 6 illustrates an example 600 of deleting temporary buckets, and that that can facilitate backup via multiple temporary dynamic cloud buckets, in accordance with an embodiment of this disclosure. In some examples, part(s) of example 600 can be used by part(s) of system architecture 100 of FIG. 1 to facilitate backup via multiple temporary dynamic cloud buckets.

Example 600 comprises cloud platform 602, target bucket 608, and data 610.

Example 600 can represent example 500 of FIG. 5 after the data in the temporary buckets-data subset 506A and data subset 506B-is copied to target bucket 508. At this point, the temporary buckets can be deleted, leaving all the data (data 610) in target bucket 608.

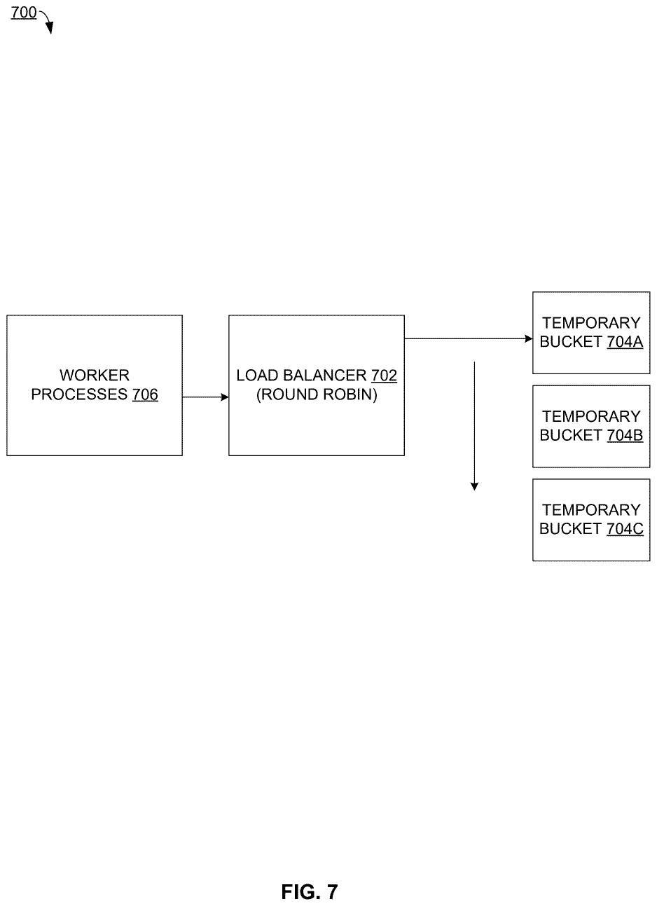

FIG. 7 illustrates an example 700 of round robin load balancing, and that that can facilitate backup via multiple temporary dynamic cloud buckets, in accordance with an embodiment of this disclosure. In some examples, part(s) of example 700 can be used by part(s) of system architecture 100 of FIG. 1 to facilitate backup via multiple temporary dynamic cloud buckets.

Example 700 comprises load balancer 702, temporary bucket 704A, temporary bucket 704B, temporary bucket 704C, and worker processes 706.

Worker processes 706 can handle copying data to the temporary buckets, and load balancer 702 can assign respective worker processes of worker processes 706 to respective temporary buckets in a round robin fashion. That is, a worker process can be assigned to copy data to temporary bucket 704A. Then, the next worker process can be assigned to copy data to temporary bucket 704B. The next worker process can be assigned to copy data to temporary bucket 704C. The next worker process can be assigned to copy data to temporary bucket 704A (a second worker process assigned to this bucket), and so on. This can aid in preventing a rate limit overload on any one bucket.

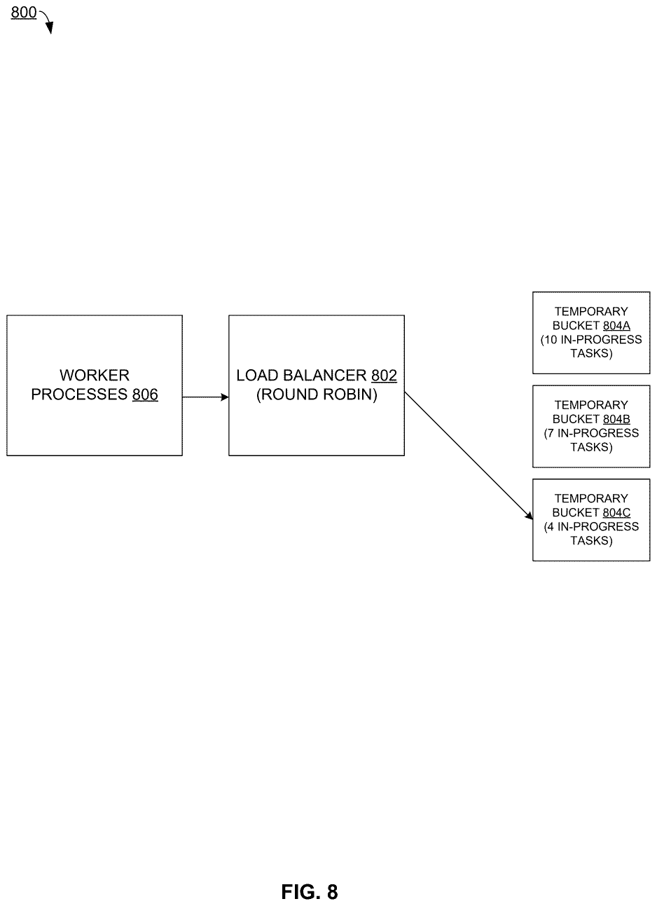

FIG. 8 illustrates an example 800 of minimum-number-of-in-progress-tasks load balancing, and that that can facilitate backup via multiple temporary dynamic cloud buckets, in accordance with an embodiment of this disclosure. In some examples, part(s) of example 800 can be used by part(s) of system architecture 100 of FIG. 1 to facilitate backup via multiple temporary dynamic cloud buckets.

Example 800 comprises load balancer 802, temporary bucket 804A, temporary bucket 804B, temporary bucket 804C, and worker processes 806.

Worker processes 806 can handle copying data to the temporary buckets, and load balancer 802 can assign respective worker processes of worker processes 806 to respective temporary buckets based on a minimum-number-of-in-progress-tasks standard.

Here, temporary bucket 804A has 10 in progress tasks, temporary bucket 804B has 7 in progress tasks, and temporary bucket 804C has 4 in progress tasks. So, the next worker process assigned by load balancer 802 can be assigned to temporary bucket 804C.

### Example Process Flows

FIG. 9 illustrates an example process flow 900 that can facilitate backup via multiple temporary dynamic cloud buckets, in accordance with an embodiment of this disclosure. In some examples, one or more embodiments of process flow 900 can be implemented by backup via multiple temporary dynamic cloud buckets component 108 of FIG. 1, or computing environment 1200 of FIG. 12.

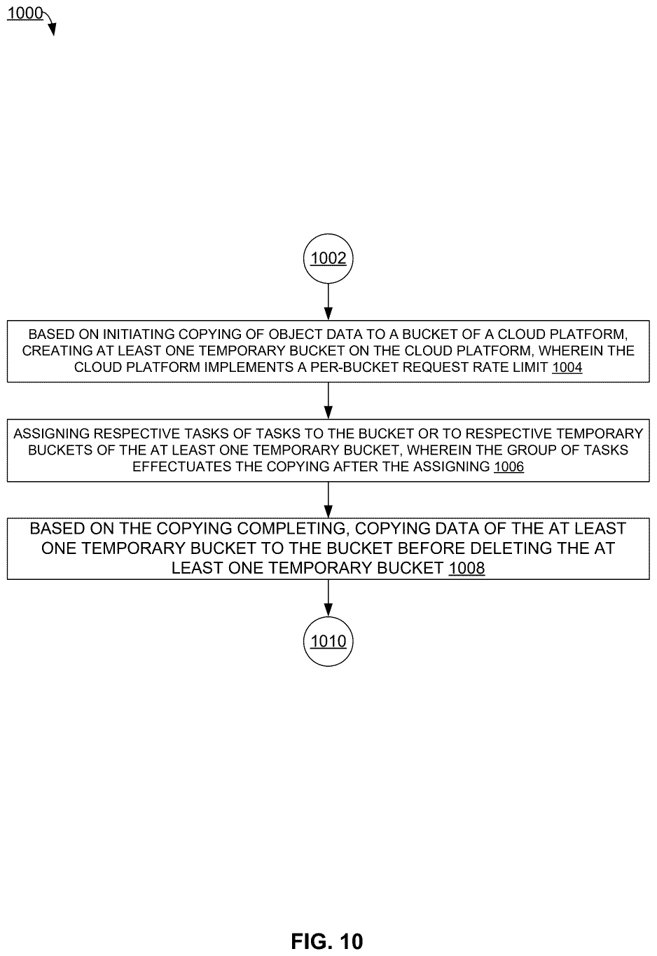

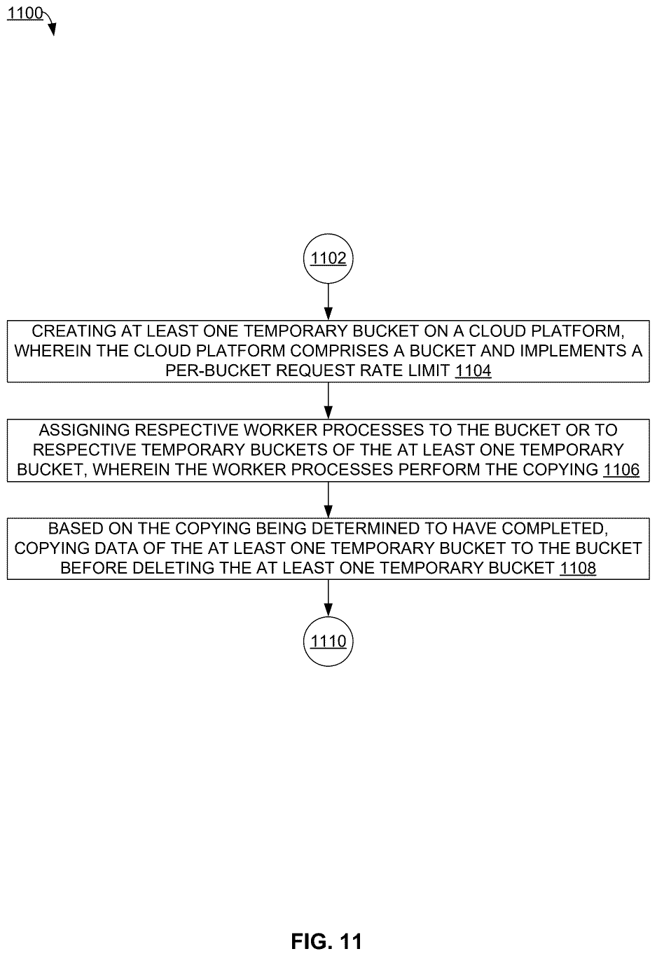

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 1000 of FIG. 10, and/or process flow 1100 of FIG. 11.

Process flow 900 begins with 902, and moves to operation 904.

Operation 904 depicts initiating copying of object data to a bucket of a cloud platform, wherein the cloud platform implements a per-bucket request rate limit, and wherein the copying is effectuated via a group of tasks. Using the example of FIG. 1, this can comprise computer system 106 copying data 110 to target bucket 114 using worker processes 112.

In some examples, the cloud platform is a first cloud platform, the per-bucket request rate limit is a first per-bucket request rate limit, a second cloud platform implements a second per-bucket request rate limit, and the first per-bucket request rate limit differs from the second per-bucket request rate limit. That is, different cloud platforms can have different rate limits, and this can be accounted for via the present techniques, such as adjusting how temporary buckets are created based on the different rate limits.

In some examples, the copying of the data of the at least one temporary bucket to the bucket comprises sending respective application programming interface calls to the cloud platform that correspond to respective temporary buckets of the at least one temporary bucket. That is, an API call can be sent to the cloud platform to move data from a temporary bucket to a target bucket, and such an API call can be made for each temporary bucket.

After operation 904, process flow 900 moves to operation 906.

Operation 906 depicts, based on the initiating, creating at least one temporary bucket on the cloud platform. Continuing with the example of FIG. 1, these can be temporary bucket(s) 116.

After operation 906, process flow 900 moves to operation 908.

Operation 908 depicts assigning respective tasks of the group of tasks to the bucket or to respective temporary buckets of the at least one temporary bucket, wherein the group of tasks effectuates the copying after the assigning. That is, continuing with the example of FIG. 1, these can be worker processes of worker processes 112 being assigned to particular buckets of the combination of target bucket 114 and temporary bucket(s) 116.

In some examples, the assigning of the respective tasks to the bucket or to the respective temporary buckets is performed based on a round-robin process. This can be implemented in a similar manner as depicted with respect to FIG. 7.

In some examples, the assigning of the respective tasks to the bucket or to the respective temporary buckets is performed based on a first load of the bucket and on respective second loads of the respective temporary buckets.

In some examples, the first load comprises a first measure of a first request rate to the bucket, and wherein the respective second loads comprise respective second measures of respective second request rates to the respective temporary buckets.

In some examples, the first load comprises a first measure of a first number of in progress tasks to the bucket, and wherein the respective second loads comprise respective second measures of respective second numbers of in progress tasks to the respective temporary buckets.

In some examples, a task associated with the tasks is assigned a selected bucket that comprises the bucket or that comprises one of the at least one temporary bucket based on the selected bucket satisfying a minimum in-progress tasks criterion.

This can be implemented in a similar manner as depicted with respect to FIG. 8.

After operation 908, process flow 900 moves to operation 910.

Operation 910 depicts, based on the copying completing, copying data of the at least one temporary bucket to the bucket, and deleting the at least one temporary bucket. Continuing with the example of FIG. 1, after copying to cloud platform 102 has completed, the data copied to temporary bucket(s) 116 can be moved to target bucket 114.

After operation 910, process flow 900 moves to 912, where process flow 900 ends.

FIG. 10 illustrates another example process flow 1000 that can facilitate backup via multiple temporary dynamic cloud buckets, in accordance with an embodiment of this disclosure. In some examples, one or more embodiments of process flow 1000 can be implemented by backup via multiple temporary dynamic cloud buckets component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 900 of FIG. 9, and/or process flow 1100 of FIG. 11.

Process flow 1000 begins with 1002, and moves to operation 1004.

Operation 1004 depicts, based on initiating copying of object data to a bucket of a cloud platform, creating at least one temporary bucket on the cloud platform, wherein the cloud platform implements a per-bucket request rate limit. In some examples, operation 1004 can be implemented in a similar manner as operations 904-906 of FIG. 9.

In some examples, operation 1104 comprises configuring a number of buckets of the at least one temporary bucket based on user input data. That is the number of temporary buckets used can be user configurable.

After operation 1004, process flow 1000 moves to operation 1006.

Operation 1006 depicts assigning respective tasks of tasks to the bucket or to respective temporary buckets of the at least one temporary bucket, wherein the group of tasks effectuates the copying after the assigning. In some examples, operation 1006 can be implemented in a similar manner as operation 908 of FIG. 9.

In some examples, operation 1006 comprises, while effectuating the copying, determining that an overloaded bucket satisfies a rate overloading criterion, wherein the overloaded bucket comprises one of the bucket or one of the at least one temporary bucket, and adding a temporary bucket to the at least one temporary bucket based on the determining that the overloaded bucket satisfies the rate overloading criterion. For example, it can be that if the total number of tasks per bucket is greater than or equal to 95% of the threshold for that bucket, a new temporary bucket can be created and added to the list of the temporary buckets for the given copy job.

In some examples, operation 1106 comprises, based on determining that a task associated with the tasks has failed with a slow down status, adding a temporary bucket to the at least one temporary bucket. In some examples, the task corresponds to a first number of data objects, a second number of requests to the cloud platform is made based on the task, and the first number equals the second number. That is, a new temporary bucket can be created if a task fails with a “slow down” request. This can be done because a batch task could have P files that result in P requests, so monitoring the total number of tasks can be insufficient.

After operation 1006, process flow 1000 moves to operation 1008.

Operation 1008 depicts, based on the copying completing, copying data of the at least one temporary bucket to the bucket before deleting the at least one temporary bucket. In some examples, operation 1008 can be implemented in a similar manner as operation 910 of FIG. 9.

After operation 1008, process flow 1000 moves to 1010, where process flow 1000 ends.

FIG. 11 illustrates another example process flow 1100 that can facilitate backup via multiple temporary dynamic cloud buckets, in accordance with an embodiment of this disclosure. In some examples, one or more embodiments of process flow 1100 can be implemented by backup via multiple temporary dynamic cloud buckets component 108 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 900 of FIG. 9, and/or process flow 1000 of FIG. 10.

Process flow 1100 begins with 1102, and moves to operation 1104.

Operation 1104 depicts creating at least one temporary bucket on a cloud platform, wherein the cloud platform comprises a bucket and implements a per-bucket request rate limit. In some examples, operation 1004 can be implemented in a similar manner as operations 904-906 of FIG. 9.

After operation 1104, process flow 1100 moves to operation 1106.

Operation 1106 depicts assigning respective worker processes to the bucket or to respective temporary buckets of the at least one temporary bucket, wherein the worker processes perform the copying. In some examples, operation 1106 can be implemented in a similar manner as operation 908 of FIG. 9.

In some examples, the assigning of the respective worker processes to the bucket or to the respective temporary buckets is performed round robin.

In some examples, the assigning of the respective worker processes to the bucket or to the respective temporary buckets is performed based on respective loads of the bucket and of the respective temporary buckets.

In some examples, the respective loads comprise respective measures of respective request rate to the bucket and to the respective temporary buckets.

In some examples, the respective loads comprise respective measures of respective in progress tasks to the bucket and to the respective temporary buckets.

In some examples, a task associated with the worker processes is assigned a selected bucket that comprises the bucket or that comprises a temporary bucket of the at least one temporary bucket based on the selected bucket satisfying a minimum in-progress tasks criterion.

In some examples, operation 1106 comprises, while performing the copying, adding a temporary bucket to the at least one temporary bucket based on determining that an overloaded bucket satisfies a rate overloading criterion, wherein the overloaded bucket comprises one of the bucket or one of the at least one temporary bucket.

After operation 1106, process flow 1100 moves to operation 1108.

Operation 1108 depicts, based on the copying being determined to have completed, copying data of the at least one temporary bucket to the bucket before deleting the at least one temporary bucket. In some examples, operation 1108 can be implemented in a similar manner as operation 910 of FIG. 9.

After operation 1108, process flow 1100 moves to 1110, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of cloud platform 102 and/or computer system 106.

In some examples, computing environment 1200 can implement one or more embodiments of the process flows of FIGS. 9-11 to facilitate backup via multiple temporary dynamic cloud buckets.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the . NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
initiating copying of object data to a bucket of a cloud platform, wherein the cloud platform implements a per-bucket request rate limit, and wherein the copying is effectuated via a group of tasks;
based on the initiating, creating at least one temporary bucket on the cloud platform;
assigning respective tasks of the group of tasks to the bucket or to respective temporary buckets of the at least one temporary bucket, wherein the group of tasks effectuates the copying after the assigning; and
based on the copying completing,
copying data of the at least one temporary bucket to the bucket, and
deleting the at least one temporary bucket.

2. The system of claim 1, wherein the cloud platform is a first cloud platform, wherein the per-bucket request rate limit is a first per-bucket request rate limit, wherein a second cloud platform implements a second per-bucket request rate limit, and wherein the first per-bucket request rate limit differs from the second per-bucket request rate limit.

3. The system of claim 1, wherein the copying of the data of the at least one temporary bucket to the bucket comprises:
sending respective application programming interface calls to the cloud platform that correspond to respective temporary buckets of the at least one temporary bucket.

4. The system of claim 1, wherein the assigning of the respective tasks to the bucket or to the respective temporary buckets is performed based on a round-robin process.

5. The system of claim 1, wherein the assigning of the respective tasks to the bucket or to the respective temporary buckets is performed based on a first load of the bucket and on respective second loads of the respective temporary buckets.

6. The system of claim 5, wherein the first load comprises a first measure of a first request rate to the bucket, and wherein the respective second loads comprise respective second measures of respective second request rates to the respective temporary buckets.

7. The system of claim 5, wherein the first load comprises a first measure of a first number of in progress tasks to the bucket, and wherein the respective second loads comprise respective second measures of respective second numbers of in progress tasks to the respective temporary buckets.

8. The system of claim 7, wherein a task associated with the tasks is assigned a selected bucket that comprises the bucket or that comprises one of the at least one temporary bucket based on the selected bucket satisfying a minimum in-progress tasks criterion.

9. A method, comprising:
based on initiating copying of object data to a bucket of a cloud platform, creating, by a system comprising at least one processor, at least one temporary bucket on the cloud platform, wherein the cloud platform implements a per-bucket request rate limit;
assigning, by the system, respective tasks of tasks to the bucket or to respective temporary buckets of the at least one temporary bucket, wherein the group of tasks effectuates the copying after the assigning; and
based on the copying completing, copying, by the system, data of the at least one temporary bucket to the bucket before deleting the at least one temporary bucket.

10. The method of claim 9, further comprising:
while effectuating the copying, determining, by the system, that an overloaded bucket satisfies a rate overloading criterion, wherein the overloaded bucket comprises one of the bucket or one of the at least one temporary bucket; and
adding, by the system, a temporary bucket to the at least one temporary bucket based on the determining that the overloaded bucket satisfies the rate overloading criterion.

11. The method of claim 10, further comprising:
based on determining that a task associated with the tasks has failed with a slow down status, adding, by the system, a temporary bucket to the at least one temporary bucket.

12. The method of claim 11, wherein the task corresponds to a first number of data objects, wherein a second number of requests to the cloud platform is made based on the task, and wherein the first number equals the second number.

13. The method of claim 9, further comprising:
configuring, by the system, a number of buckets of the at least one temporary bucket based on user input data.

14. A non-transitory computer-readable medium comprising instructions that, in response to execution, cause a system comprising at least one processor to perform operations, comprising:
creating at least one temporary bucket on a cloud platform, wherein the cloud platform comprises a bucket and implements a per-bucket request rate limit,
assigning respective worker processes to the bucket or to respective temporary buckets of the at least one temporary bucket, wherein the worker processes perform the copying; and
based on the copying being determined to have completed, copying data of the at least one temporary bucket to the bucket before deleting the at least one temporary bucket.

15. The non-transitory computer-readable medium of claim 14, wherein the assigning of the respective worker processes to the bucket or to the respective temporary buckets is performed round robin.

16. The non-transitory computer-readable medium of claim 14, wherein the assigning of the respective worker processes to the bucket or to the respective temporary buckets is performed based on respective loads of the bucket and of the respective temporary buckets.

17. The non-transitory computer-readable medium of claim 16, wherein the respective loads comprise respective measures of respective request rate to the bucket and to the respective temporary buckets.

18. The non-transitory computer-readable medium of claim 16, wherein the respective loads comprise respective measures of respective in progress tasks to the bucket and to the respective temporary buckets.

19. The non-transitory computer-readable medium of claim 18, wherein a task associated with the worker processes is assigned a selected bucket that comprises the bucket or that comprises a temporary bucket of the at least one temporary bucket based on the selected bucket satisfying a minimum in-progress tasks criterion.

20. The non-transitory computer-readable medium of claim 14, wherein the operations further comprise:
while performing the copying, adding a temporary bucket to the at least one temporary bucket based on determining that an overloaded bucket satisfies a rate overloading criterion, wherein the overloaded bucket comprises one of the bucket or one of the at least one temporary bucket.
